(19) United States
(12) Patent Application Publication
(10) Pub. No.: US 2011/0234900 A1
(43) Pub. Date: Sep. 29, 2011

(54) METHOD AND APPARATUS FOR IDENTIFYING VIDEO PROGRAM MATERIAL OR CONTENT VIA CLOSED CAPTION DATA

(75) Inventor: Ronald Quan, Cupertino, CA (US)

(73) Assignee: Rovi Technologies Corporation

(21) Appl. No.: 12/748,656

(22) Filed: Mar. 29, 2010

(51) Int. Cl. H04N 7/00

(52) U.S. Cl. 348/468; 348/E07.001

(57) ABSTRACT

A system for identification of video content in a video signal is provided via the use of closed caption or other data in a video signal or transport stream such as MPEG-x. Sampling of the received video signal or transport stream allows capture of dialog from a movie or video program. The captured dialog is compared to a reference library or database for identification purposes. Other attributes of the video signal or transport stream may be combined with closed caption data or closed caption text for identification purposes. Example attributes include time code information, histograms, and or rendered video or pictures.

### BACKGROUND

The present invention relates to identification of video content (i.e., video program material) such as movies, television (TV) programs, and the like.

Previous methods for identifying video content included watermarking each frame of the video program. However, the watermarking process requires that the video content be watermarked prior to distribution and or transmission.

### SUMMARY

An embodiment of the invention provides identification of video content without necessarily altering the video content via fingerprinting or watermarking prior to distribution or transmission. Closed caption data is added or inserted with the video program for digital video disc (DVD), Blu Ray, or transmission. The closed caption data, may be represented by an alpha-numeric text code. Text (data) consumes much less bits or bytes than video or musical signals. Therefore, an example of the invention may include one or more of the following functions/systems:

1) A library or database of closed caption data such as dialog or words used in the video content.

2) Receiving and retrieving closed caption data via a recorded medium or via a link (e.g., broadcast, phone line, cable, IPTV, RF transmission, optical transmission, or the like).

3) Comparing the closed caption data, which may be converted to a text file, to the closed caption data or closed caption text data of the library or database.

4) Alternatively, the library or database may include script(s) from the video program (e.g., a movie script) to compare with the closed caption data (or closed caption text data) received via the recorded medium or link.

5) Time code received for audio (e.g., AC-3), and or for video, may be combined with any of the above examples 1-4 for identification purposes.

In one embodiment of the invention, a short sampling of the video program is made, such as anywhere from one TV field's duration (e.g., 1/60 or 1/50 of a second) to one or more seconds. In this example, the closed caption signal exists, so it is possible to identify the video content or program material based on sampling a duration of one (or more) frame or field. Along with capturing the closed caption signal, a pixel or frequency analysis of the video signal maybe done as well for identification purposes.

For example, a relative average picture level in one or more section (e.g., quadrant, or divided frame or field) during the capture or sampling interval, may be used.

Another embodiment may include histogram analysis of, for example, the luminance (Y) and or signal color (e.g., (R-Y); and or (B-Y) or I, Q, U, and or V), or equivalent such as Pr and or Pb channels. The histogram may map one or more pixels in a group throughout at least a portion of the video frame for identification purposes. For a composite, S-Video, and or Y/C video signal or RF signal, a distribution of the color subcarrier signal may be provided for identification of a program material. For example a distribution of subcarrier amplitudes and or phases (e.g., for an interval within or including 0 to 360 degrees) in selected pixels of lines and or fields or frames may be provided to identify video program material. The distribution of subcarrier phases (or subcarrier amplitudes) may include a color (subcarrier) signal whose saturation or amplitude level is above or below a selected level. Another distribution pertaining to color information for a color subcarrier signal includes a frequency spectrum distribution, for example, of sidebands (upper and or lower) of the subcarrier frequency such as for NTSC, PAL, and or SECAM, which may be used for identification of a video program. Windowed or short time Fourier Transforms may be used for providing a distribution for the luminance, color, and or subcarrier video signals (e.g., for identifying video program material).

An example of a histogram divides at least a portion of a frame into a set of pixels. Each pixel is assigned a signal level. The histogram thus includes a range of pixel values (e.g., 0-255 for an 8 bit system) on one axis, and the number of pixels falling into the range of pixel values are tabulated, accumulated, and or integrated.

In an example, the histogram has 256 bins ranging from 0 to 255. A frame of video is analyzed for pixel values at each location f(x,y).

If there are 1000 pixels in the frame of video, a dark scene would have most of the histogram distribution in the 0-10 range for example. In particular, if the scene is totally black, the histogram would have a reading of 1000 for bin 0, and zero for bins 1 through 255. Of course the number of bins may include a group of two or more pixels.

Alternatively, in the frequency domain, Fourier, DCT, or Wavelet analysis may be used for analyzing one or more video field and or frame during the sampling or capture interval.

Here the coefficients of Fourier Transform, Cosine Transform, DCT, or Wavelet functions may be mapped into a histogram distribution.

To save on computation, one or more field or frame may be transformed to a lower resolution picture for frequency analysis, or pixels may be averaged or binned.

Frequency domain or time or pixel domain analysis may include receiving the video signal and performing high pass, low pass, band eject, and or band pass filtering for one or more dimensions. A comparator may be used for ‘slicing” at a particular level to provide a line art transformation of the video picture in one or two dimensions. A frequency analysis (e.g., Fourier or Wavelet, or coefficients of Fourier or Wavelet transforms) may be done on the newly provide line art picture. Alternatively, since line art pictures are compact in data requirements, a time or pixel domain comparison between the library's or data base's information may be compared with a received video program that has been transformed to a line art picture.

The data base and or library may then include pixel or time domain or frequency domain information based on a line art version of the video program, to compare against the sampled or captured video signal. A portion of one or more fields or frames may be used in the comparison.

In another embodiment, one or more fields or frames may be enhanced in a particular direction to provide outlines or line art. For example, a picture is made of a series of pixels in rows and columns. Pixels in one or more rows may be enhanced for edge information by a high pass filter function along the one dimensional rows of pixels. The high pass filtering function may include a Laplacian (double derivative) and or a Gradient (single derivative) function (along at least one axis). As a result of performing the high pass filter function along the rows of pixels, the video field or frame will provide more clearly identified lines along the vertical axis (e.g., up-down, down-up), or perpendicular or normal to the rows.

Similarly, enhancement of the pixels in one or more columns provides identified lines along the horizontal axis (e.g., side to side, or left to right, right to left), or perpendicular or normal to the columns.

The edges or lines in the vertical and or horizontal axes allow for unique identifiers for one or more fields or frames of a video program. In some cases, either vertical or horizontal edges or lines will be sufficient for identification purposes, which provides less (e.g., half) the computation for analysis than analyzing for curves of lines in both axes.

It is noted that the video program's field or frame may be rotated, for example, at an angle in the range of 0-360 degrees, relative to an X or Y axis prior or after the high pass filtering process, to find identifiable lines at angles outside the vertical or horizontal axis.

### BRIEF DESCRIPTION OF THE FIGURES

FIG. 1 is a block diagram illustrating an embodiment of the invention utilizing alpha and or numerical text data.

FIG. 2 is a block diagram illustrating another embodiment of the invention utilizing one or more data readers.

FIG. 3 is a block diagram illustrating an embodiment of the invention utilizing any combination of histogram, teletext, time code, and or a movie/program script data base.

FIG. 4 is a block diagram illustrating an embodiment of the invention utilizing a rendering transform or function.

FIGS. 5A-5D are pictorials illustrating examples of rendering.

### DETAILED DESCRIPTION

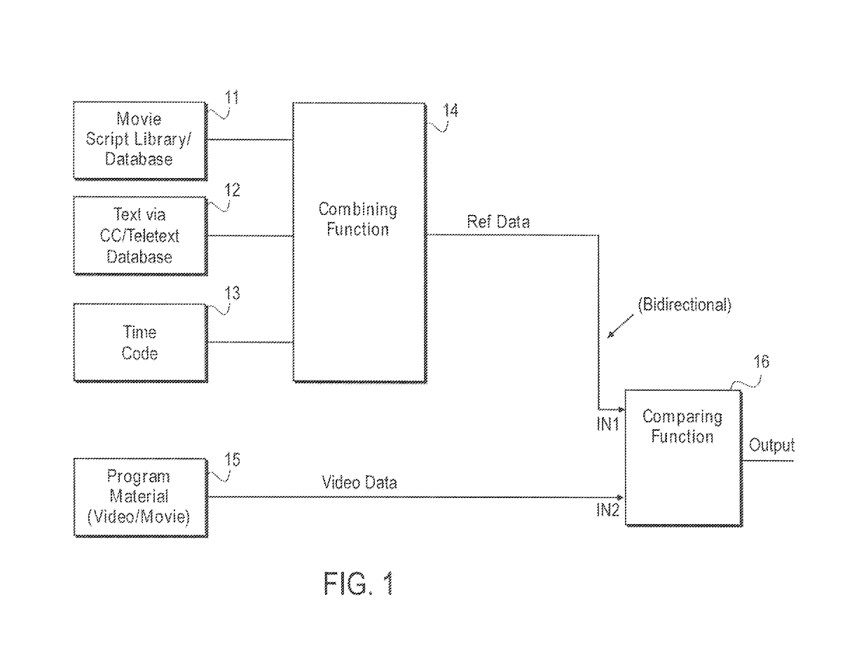

FIG. 1 illustrates an embodiment of the invention for identifying program material such as movies or television programs. A system for identifying program material includes a movie script library or database 11, which includes dialog of the performers, a closed caption data base or text data base from closed caption signals, and or time code that may be used to locate a particular phrase or word during the program material.

The movie script library/database 11 includes the dialogs of the characters of the program material. The scripts may be divided by chapters, or may be linked to a time line in accordance with the program (e.g., movie, video program). The stored scripts may be used for later retrieval.

A text or closed caption data base 12 includes text that is converted from closed caption or the closed caption data signals (e.g., which are stored and may be retrieved later). The closed caption signal may be received from a vertical blanking interval signal or from a digital television data or transport stream (e.g., such as MPEG-x)

Time code data 13, which is tied or related to the program material, provides another attribute to be used for identification purposes. For example, if the program material has a closed caption phrase or word or text of “X” at a particular time, the identity of the program material can be sorted out faster or more efficiently.

The information from blocks 11, 12, and or 13 is supplied to a combining function (depicted as block 14), which generates reference data. This reference data is supplied to a comparing function (depicted as block 16). Function 16 also receives data from a program material source 15, which data may be a segment of the program material (e.g., 1 second to >1 minute). Video data from source 15 may include closed caption information, which then may be compared to closed caption information or signals from the reference data, supplied via the closed caption database 12, or script library/database 11. Time code information from the program material source 15 may be included and used for comparison purposes with the reference data.

The comparing function 16 may include a controller and or algorithm to search, via the reference data, incoming information or signals (e.g., closed caption signals or text information from the program material source 15).

The output of the comparing function 16, after one or more segments, is analyzed to provide an identified title or other data (names of performers or crew) associated with the received program material.

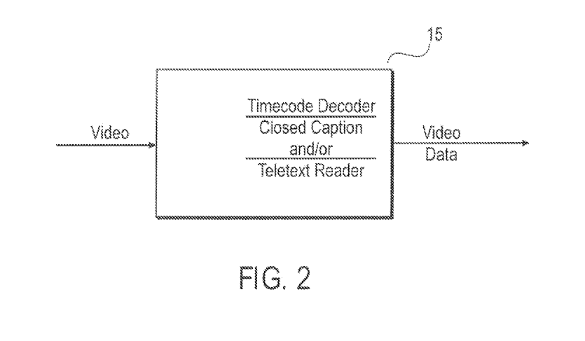

FIG. 2 illustrates a video source, which may be an analog or digital source, such as illustrated by the program material source 15 of FIG. 1. For an analog source, the data such as teletext or closed caption is located in an overscan or blanking area of the video signal. For example, teletext, time code, data, and or closed caption data is located in the vertical blanking interval (VBI). In some cases, a horizontal blanking interval (HBI), or one or more unused video line(s) of the video frame or video field, provides a location for the teletext, time code, data, and or closed caption data.

For a digital video source, the closed caption, teletext, subtitle (one or more languages), and or time code signal is embedded as a bit pattern in a digital video signal. One example, inserts any of the signals mentioned in an MPEG-x bit stream. The digital video signal may be provided from recorded media such as a CD, DVD, BluRay, hard drive, tape, or solid state memory. Transmitted digital video signals may be provided via a digital delivery network, LAN, Internet, intranet, phone line, WiFi, WiMax, cable, RF, ATSC, DTV, and or HDTV.

The program material source 15 for example includes a time code, closed caption, and or teletext reader for reading the received digital or analog video signal.

The output of the reader(s) thus includes a time code, closed caption, and or teletext signal, (which may be converted to text symbols) for comparing against a database or library for identification purpose(s).

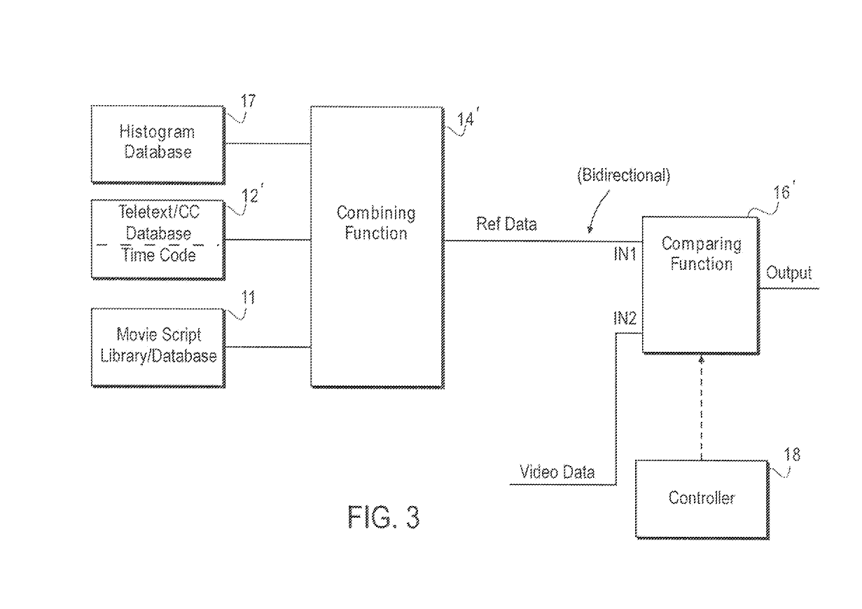

FIG. 3 illustrates another embodiment of the invention, which includes histogram information from a histogram database 17. For identifying a movie or program, any combination of histogram, teletext, time code, closed caption, and or (movie) script may be used.

Histogram information may include pixel (group) distribution of luminance, color, and or color difference signal. Alternatively, histogram information may include coefficients for cosine, Fourier, and or Wavelet transforms. The histogram may provide a distribution over an area of the video frame or field, or over specific lines/segments (e.g., of any angle or length), rows, and or columns.

For example, for each movie or video program stored in a database or library, histogram information is provided for at least a portion of a set of frames or fields or lines/segments. A received video signal then is processed to provide histogram data, which is then compared to the stored histograms in the database or library to identify a movie or video program. With the data from closed caption, time code, or teletext combined with the histogram information, identification of the movie or video program is provided, which may include a faster or more accurate search.

The histogram may be sampled every N frames to reduce storage and or increase search efficiency. For example, sampling for pixel distribution or coefficients of transforms in a periodic but less than 100% duty cycle, allows more efficient or faster identification of the video program or movie.

Similarly in the MPEG-x or compressed video format, information related to motion vectors or change in a scene may be stored and compared against incoming video that is to be identified. Information in selected P frames and or I frames may be used for the histogram for identification purposes.

In some video transport streams, pyramid coding is done to allow providing video programming at different resolutions. In some cases using lower resolution representation of any of the video field or frame (mentioned) may be utilized for identification purposes (e.g., for less storage and or more efficient/faster identification).

Radon transforms may be used as a method of identifying program material. In the Radon transform, line or segments pivoted/rotated on an origin (e.g., (0,0) for (ω1,ω2) of the plane of two dimension Fourier or Radon coefficients. By generating the Radon transform for specific discrete angles such as fractional multiples of π, (kπ) where k<1 and a rational or real number, the number of coefficients of the video picture's frame or field calculations is reduced. By using an inverse Radon transform, an approximation of a selected video field or frame is reproduced or provided, which can be used for identification purposes.

The coefficients of the Radon transform as a function of angle may be mapped into a histogram representation, which can be used for comparison against a known database of Radon transforms for identification purposes.

FIG. 3 illustrates, via the block 17, a histogram database of video programs or movies coupled to a combining function, for example, combining function 14′. Since the circuits of FIG. 3 are generally similar to those of FIG. 1, like components in FIG. 3 are identified by similar numerals with addition of a prime symbol. Also coupled to the combining function 14′ is a database 12′ for providing teletext, closed caption, and or time code signals. A script library or database 11′ also may be coupled to combining function 14′. Any combination of the blocks 17, 12′, and or 11 may be used via the combining function 14′ as reference data for comparing, via a comparing function 16′, against a received video data signal supplied to an input In2 of function 16′, to identify a selected video program or movie. A controller 18 may retrieve reference data via the blocks 14′, 17, 12′, and or 11 when searching for a closest match to the received video data.

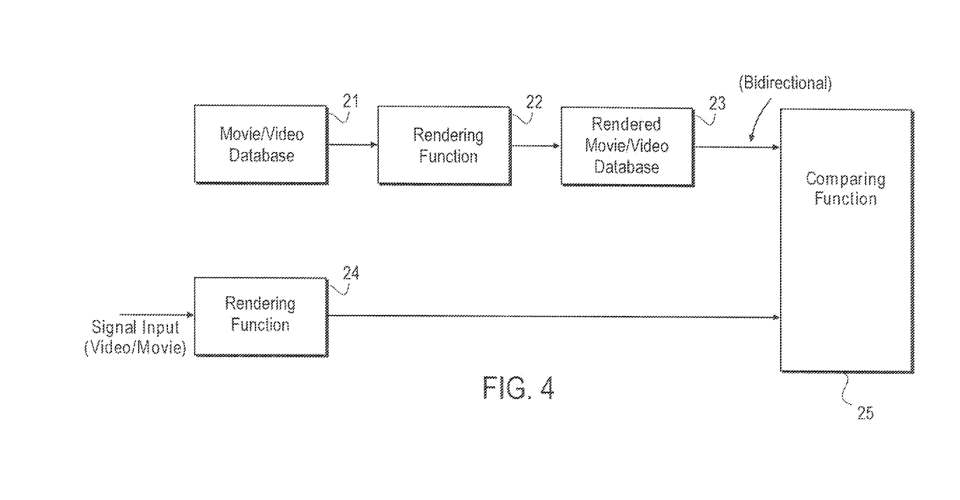

FIG. 4 illustrates an alternative embodiment for identifying movies or video programs. A movie or video database 21, is rendered via rendering function or circuit 22 to provide a “sketch” of the original movie or video program. For example, a 24 bit color representation of a video frame or field is reduced to a line art picture in color or black and white. The line art picture provides sufficient details or outlines of selected frames or fields of the video program for identification purposes (while reducing required storage space). The rendered movie or video programs are stored in a database 23 for subsequent comparison with a received video program. A first input of a comparing function or circuit 25 is coupled to the output of the rendered movie or video program database 23. The received video program is also rendered via a rendering function or circuit 24 and coupled to a comparing function or circuit 25 via a second input.

An output of the comparing function/circuit 25 provides an identifier for the video signal received by the rendering function/circuit 24.

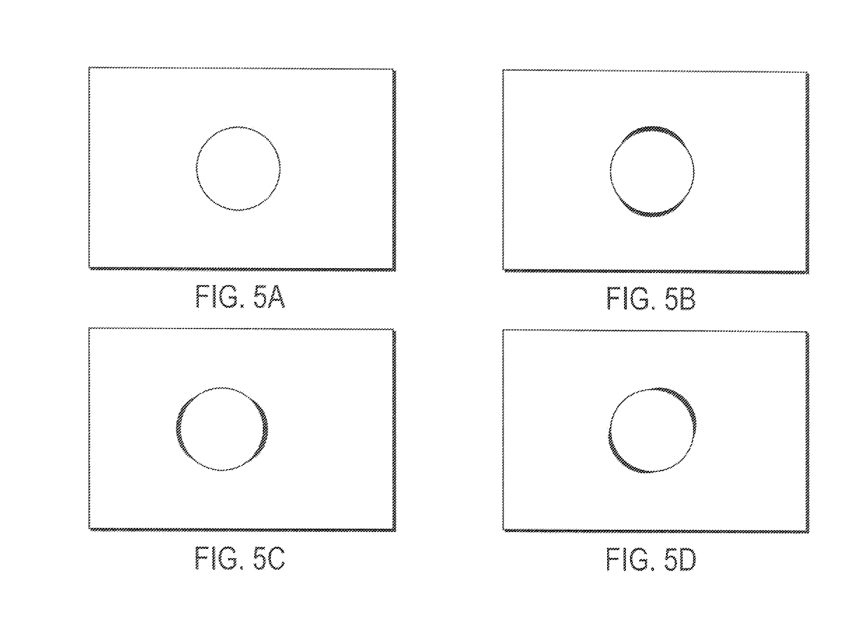

FIG. 5A-FIG. 5D illustrate an example of rendering, which may be used for identification purposes. FIG. 5A shows a circle prior to rendering.

FIG. 5B shows the circle rendered via a high pass filter function (e.g., gradient or Laplacian, single derivative or double derivative) in the vertical direction (e.g., y direction). Here, edges conforming to a horizontal direction are emphasized, while edges conforming to an up-down or vertical direction are not emphasized. In video processing, FIG. 5B represents an image that has received vertical detail enhancement.

FIG. 5C represents an image rendered via a high pass filter function in the horizontal direction, also known as horizontal detail enhancement. Here, edges conforming to an up-down or vertical direction are emphasized, while edges in the horizontal direction are not.

FIG. 5D represents an image rendered via a high pass filter function at an angle relative to the horizontal or vertical direction. For example, the high pass filter function may apply horizontal edge enhancement by zigzagging pixels from the upper left corner or lower right corner of the video field or frame. Similarly zigzagging pixels from the upper right corner or lower left corner and applying vertical edge enhancement will provide enhanced edges at an angle to the X or Y axes of the picture.

By using thresholding or comparator techniques to pass through the enhanced edge information on video programs, profiles of the location of the edges are stored for comparison against a received video program rendered in substantially the same manner. The edge information allows a greater reduction in data compared to the original field or frame of video.

The edge information may include edges in a horizontal, vertical, off axis, and or a combination of horizontal and vertical direction(s), which may be used for identification purposes.

This disclosure is illustrative and not limiting. For example, an embodiment need not include all blocks illustrated in any of the figures. A subset of blocks within any figure may be used as an embodiment. Further modifications will be apparent to those skilled in the art in light of this disclosure and are intended to fall within the scope of the appended claims.

What is claimed is:

1. A system for identifying video program material in a video signal comprising:
a database of closed caption signals or closed caption text;
an input for receiving the video signal;
a reader circuit receiving the video signal via the input, wherein the reader circuit provides a closed caption signal or closed caption text; and
a comparing function/circuit for comparing the read closed caption signal or closed caption text to the database of closed caption signals or closed caption text, for identification of the video program material.

2. The system of claim 1 further comprising:
a time code data base linked to the closed caption signal or text database and a time code reader to provide time code from the received video signal; and
wherein the comparing function/circuit includes comparing the time code linked to a portion of the closed caption signal or closed caption text from the data base and the time code linked to a portion of the closed caption signal or closed caption text from the received video signal.

3. The system of claim 1 further comprising:
a histogram database containing histogram information of one or more video field or frame, which is linked to the closed caption signal or closed caption text.

4. The system of claim 3 wherein the histogram information includes luminance values.

5. The system of claim 3 wherein the histogram information includes coefficients of Wavelet, Fourier, Cosine, DCT, and or Radon transforms.

6. The system of claim 1 further comprising:
a database of rendered movies or video programs which are compared to the received video program material that is rendered for identifying the video program material.

7. The system of claim 6 wherein a gradient or Laplacian transform provides the function of rendering.

8. A method of identifying video program material in a video signal comprising:
providing a database of closed caption signals or closed caption text;
supplying the video signal to a reader, wherein the reader provides a read closed caption signal or closed caption text; and
comparing the read closed caption signal or closed option text to the database of closed caption signals or closed caption text, for identification of the video program material.

9. The method of claim 8 further comprising:
reading time code from the received video signal via a time code database linked to the closed caption signal or closed caption text database; and
comparing the time code linked to a portion of the closed caption signal or closed caption text from the database, with the time code linked to a portion of the closed caption signal or closed caption text from the received video signal.

10. The method of claim 8 further comprising:
providing histogram information of one or more video field or frame which is linked to the closed caption signal or closed caption text.

11. The method of claim 10 wherein the histogram information includes luminance and or subcarrier phase values.

12. The method of claim 10 wherein the histogram information includes coefficients of Wavelet, Fourier, Cosine, DCT, and or Radon transforms.

13. The method of claim 8 further comprising:
providing rendered movies or video programs; and
comparing the rendered movies or video programs with the received video program material that is rendered, for identifying the video program material.

14. The method of claim 13 wherein a gradient or Laplacian transform provides the function of rendering.
